(19) United States
(12) Patent Application Publication
(10) Pub. No.: US 2008/0028430 A1
(43) Pub. Date: Jan. 31, 2008

(54) Control gateways that control consumer electronic devices responsive to RF command signals

(76) Inventors: Barrett Kreiner, Woodstock, GA (US); Jonathan Reeves, Roswell, GA (US)

Correspondence Address: MYERS BIGEL SIBLEY & SAJOVEC, P.A., P.O. BOX 37428, RALEIGH, NC, 27627, US

(21) Appl. No.: 11/583,225

(22) Filed: Oct. 19, 2006

Related U.S. Application Data
(60) Provisional application No. 60/834,225, filed on Jul. 28, 2006.

(51) Int. Cl. H04H 7/00; H04N 7/18

(52) U.S. Cl. 725/78; 455/3.06

(57) ABSTRACT

A control gateway is configured to control at least one consumer electronic device. The control gateway includes an optical transmitter unit, a radio frequency (RF) transceiver unit, and a controller. The optical transmitter unit is configured to transmit optical signals compatible with a first type of consumer electronic device. The RF transceiver unit is configured to receive RF signals. The controller is configured to generate an output command configured to control the first type of consumer electronic device in response to RF signals received by the RF transceiver unit, and to communicate the output command through the optical transmitter unit to the first type of consumer electronic device. Related methods of controlling at least one consumer electronic device from a control gateway are also disclosed.

### CROSS REFERENCE RELATED APPLICATIONS

This Application is related to and claims the benefit of priority to U.S. Provisional Patent Application No. 60/834,225, filed Jul. 28, 2006, entitled RADIO AND LIGHT CONVERSION GATEWAY APPARATUS AND RELATED METHODS AND SYSTEMS, the disclosure of which is hereby incorporated herein by reference.

### FIELD OF THE INVENTION

This invention relates to consumer electronic devices and, more particularly, to controlling consumer electronic devices that receive infra-red (IR) command signals.

### BACKGROUND OF THE INVENTION

There is an increasing trend in the proliferation of different types and manufacturers (i.e., brands) of consumer electronic devices (e.g., TVs, Video Cassette Recorders (VCRs), Digital Video Disk (DVD) players, recordable DVD (DVD R/W) devices, Digital Video Recorders (DVRs), satellite television tuners, cable television tuners, satellite/terrestrial radio tuners, photo/video/sound multimedia centers, etc.), with each typically controlled by a different device specific remote control (DSRC). Some consumers have therefore accumulated numerous DSRCs which are each necessary for controlling different ones of those electronic devices owned by the consumers. Unfortunately, these DSRCs can be viewed as undesirable clutter in one's home, and inadvertent misplacement of one of the DSRCs can result in a complete or partial loss of ability to control the corresponding electronic device.

Universal remote controls (URC) have been introduced to reduce the clutter and dependency on numerous DSRCs. An URC typically can be programmed to control one or more electronic devices and, thus, can replace one or more DSRCs. For some URCs, a user is provided with a manual which includes code sets for a plurality of DSRCs. The user is tasked with determining the correct code set corresponding to each DSRC to be programmed into the URC, and then manually entering that code set into the URC. This process may be tedious and time consuming. Further, if the manual for the URC is lost, the user may not be able to program/reprogram the URC. In addition, the types and brands of DSRCs that may be programmed into the URC are limited to the code sets provided in the manual at the time of publishing.

Some URCs are capable of being programmed without requiring the user to manually enter a code set. This type of URC is typically able to operate in a so-called “learning mode,” where the URC is able to duplicate a signal received from each key of a DSRC and store that signal in memory. Programming a URC in a learning mode may have several drawbacks. First, the URC may only duplicate signals from DSRC keys that are physically pressed by the user. Thus, the user should press every one of the function keys on a DSRC that is desired to be programmed into, and reproduced by, the URC. While this learning mode may be acceptable for a DSRC having a relatively small number of function keys, it may inconvenient and time consuming for programming a URC to duplicate a DSRC having a large number of function keys and/or to duplicate many different DSRCs. Additionally, the complexity and cost of the URC can rise relative to its capability to program larger numbers and varieties of functional keys of DSRCs.

DSRCs and URCs include an infrared transmitter that generates infrared (IR) control signals. These IR control signals can be received by a consumer electronic device through a control window, usually located on a front face of the electronic device. For the IR control signals to successfully reach the electronic device, the DSRC/URC typically needs to be aimed at the control window of the electronic device and the line-of-sight path there between needs to be unobstructed.

Further improvements in controlling consumer electronic devices may be desired in view of the continued proliferation of different types and brands of consumer electronic devices and potential drawbacks with the cost, functionality, and/or operation of DSRCs and/or URCs.

### SUMMARY OF THE INVENTION

Some embodiments of the present invention are directed to a control gateway that is configured to control at least one consumer electronic device. The control gateway includes an optical transmitter unit, a radio frequency (RF) transceiver unit, and a controller. The optical transmitter unit is configured to transmit optical signals compatible with a first type of consumer electronic device. The RF transceiver unit is configured to receive RF signals. The controller is configured to generate an output command configured to control the first type of consumer electronic device in response to RF signals received by the RF transceiver unit, and to communicate the output command through the optical transmitter unit to the first type of consumer electronic device. Accordingly, the control gateway may thereby translate RF signals from a RF communication device, such as a PDA, into IR or other optical control signals which can be used to control one or more consumer electronic devices.

Some other embodiments of the present invention are directed to related methods of controlling at least one consumer electronic device from a control gateway.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of a system and related methods in which a control gateway controls two consumer electronic device in response to radio frequency (RF) and/or IR command signals according to some embodiments of the present invention.

FIG. 2 is a block diagram of another system and related methods in which a plurality of control gateways control various consumer electronic device in response to RF and/or IR command signals according to some embodiments of the present invention.

FIG. 3 is a flowchart of methods for converting RF control signals to IR control signals according to some embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another elements, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Embodiments of the present invention are directed to control gateways that can interface RF control signals to optical control signals to control functionality of consumer electronic devices. As used herein, “optical control signals” includes IR and other optical wavelength signals, including near-IR, visible, and ultra-violet wavelength signals. Accordingly embodiments of the present invention are discussed below in the context of controlling consumer electronic devices using IR control signals, however it is to be understood that other optical wavelength control signals may be used.

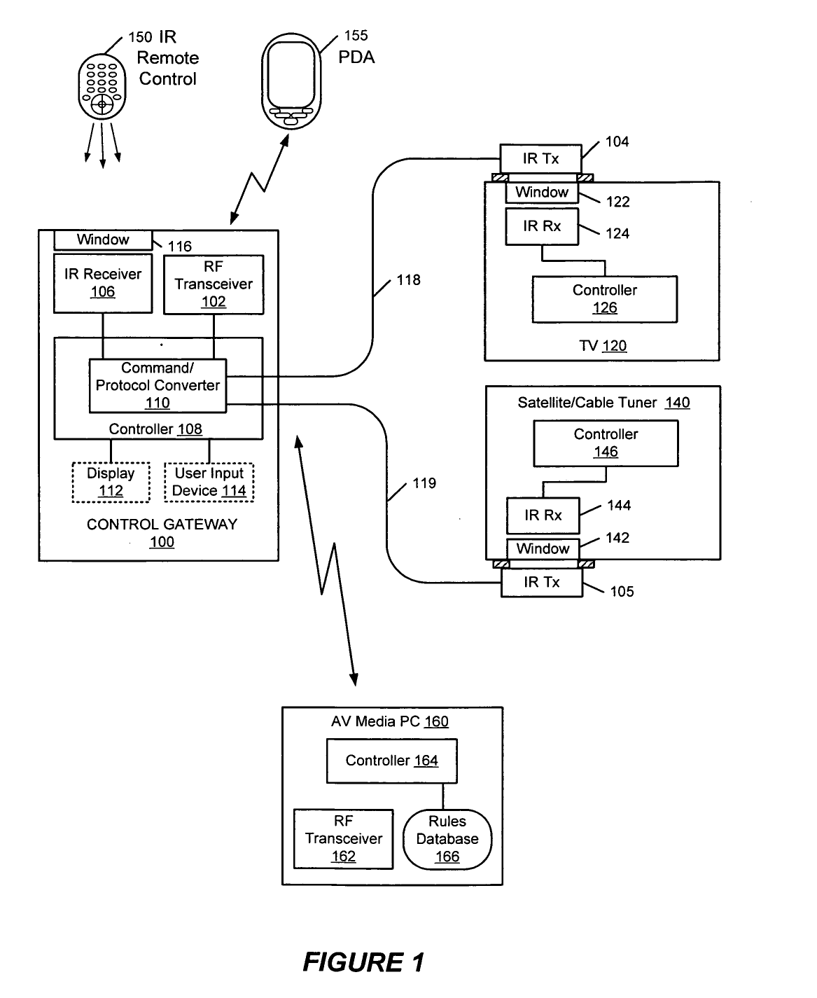

FIG. 1 is a block diagram of a system and related methods in which a control gateway 100 controls two consumer electronic devices 120 and 140 in response to RF and/or IR command signals according to some embodiments of the present invention. By way of example only, one consumer electronic device 120 is referred to as a TV and the other consumer electronic device 140 is referred to as a satellite/cable tuner, however the consumer electronic devices 120 and 140 may be any type of consumer product that is controllable in response to optical control signals, including, but not limited to, a TV, a VCR, a DVD player (including standard/high definition format), a DVD R/W device, a DVR, satellite television tuner, a cable television tuner, a satellite/terrestrial radio tuner, a photo/video/sound multimedia center, etc.

The control gateway 100 is configured to receive RF control signals from a PDA 155 or other RF communication device (e.g., desktop/laptop/palmtop computer), and in response thereto can generate IR control signals having a first protocol that is configured to control the TV 120. The control gateway 100 may also respond to the received RF control signals by generating IR control signals having a second protocol configured to control the satellite/cable tuner 140, and where the second protocol is different from the first protocol. The control gateway 100 can thereby convert the RF control signals into IR control signals configured to control the TV 120 and/or the satellite/cable tuner 140. Accordingly, the control gateway 100 may operate to allow the PDA 155 and/or another type of RF communication device to be used to control one or more functions of one or more consumer electronic devices which are controlled via optical control signals, such as the TV 120 and/or the satellite/cable tuner 140.

The control gateway 100 may convert IR control signals that it receives from another device, such as an IR remote control 150, and which IR control signals have a protocol different from the first and second protocols, into IR control signals having the first protocol so as to control the TV 120 and/or into IR control signals having the second protocol so as to control the satellite/cable tuner 140. Accordingly, the control gateway 100 may operate to translate first IR control signals received from an IR remote control, and which are not configured to control the TV 120 and/or the satellite/cable tuner 140, into second IR control signals having a protocol that is configured to control the TV 120 and/or the satellite/cable tuner 140. Thus, for example, the control gateway 100 may translate IR control signals received from a Sony brand TV remote control into IR control signals that can be used to control a Sharp brand television, DVR, satellite/cable tuner, and/or satellite/terrestrial radio tuner.

The control gateway 100 may include a RF transceiver 102, a first IR transmitter (Tx) 104, a second IR transmitter 105, an IR receiver 106, and a controller 108, and may further include a display 112 and/or a user input device 114. The controller 108 may include a command/protocol converter 110. The optional display 112 and user input device (e.g., keypad, logic switches, . . . ) may be used to control operation of the control gateway 100. Although the exemplary control gateway 100 is illustrated with one RF transceiver 102, one IR receiver 106, and two IR transmitters 104 and 105, it is to be understood that any number of IR receivers/transmitters and/or RF transceivers may be utilized according to various embodiments of the present invention.

The RF transceiver 102 is configured to receive commands from the Personal Data Assistant (PDA) 155, or another RF communication device (e.g., wireless data terminal, desktop computer, laptop computer, palmtop computer, etc.), via RF signals according to a RF protocol that may include, but is not limited to, Bluetooth, Wireless Local Area Network (WLAN) (e.g., 802.11 b-g, or related standard), WiMAX, and/or other RF communication protocol. The IR receiver 106 is configured to receive commands via IR signals received from the IR remote control 150, or another IR communication device, through a window 116 in a housing of the control gateway 110. The first and second IR transmitters 104, 105 are configured to transmit IR signals which are capable of controlling the TV 120 and the satellite/cable tuner 140, respectively. The first and second IR transmitters 104, 105 may be at least partially disposed within the same packaging as the RF transceiver 102, the IR receiver 106, and the controller 108, or they may each be separately packaged therefrom, such as illustrated in FIG. 1. The command/protocol converter 110 is configured to convert commands received through the RF transceiver 102 and IR receiver 106 into commands having a protocol that is configured to control at least some functions of the TV 120 and the satellite/cable tuner 140 and which are transmitted through the first and second IR transmitters 104, 105.

By way of example, a user may utilize the PDA to carry out desired actions in the TV 120 and/or the satellite/cable tuner 140, such as turning-on/off the TV 120 and satellite/cable tuner 140, selecting a channel for the TV 120 and/or the satellite/cable tuner 140, adjusting volume of the TV 120, and/or controlling other functions of the TV 120 and/or the satellite/cable tuner 140. The user may manually operate the PDA 155 to cause transmission of one or more commands to carry out those functions and/or may program the PDA 155 to automatically generate the one or more commands in response to a defined event, such as in response to occurrence of a time of day and/or receipt of a defined message (i.e., email and/or instant message) or signal from another electronic device. The command/protocol converter 110 converts the received command(s) into other command(s) having one or more protocols that are configured to control the TV 120 and the satellite/cable tuner 140 to accomplish the desired actions.

By way of further example, the control gateway 100 may operably interface the IR remote control 150, which is not configured to control the TV 120 or satellite/cable tuner 140, to the TV 120 and the satellite/cable tuner 140. The command/protocol converter 110 converts a command(s) received via the IR receiver 106 from the IR remote control 150 into other command(s) having one or more protocols that are configured to control the TV 120 and the satellite/cable tuner 140 to accomplish the desired actions. Accordingly, by use of the control gateway 100, the IR remote control 150 may be used to control electronic devices which it is not otherwise configured to control.

An Audio-Video (AV) media PC 160 may be used to assist with control by the control gateway 100 of the TV 120 and/or the satellite/cable tuner 140. The AV media PC 160 may include a RF transceiver 162, a controller 164,.and a rules database 166. The control gateway 100 may respond to a command(s)-received from the PDA 155 and/or IR remote control 150 by communicating an action query to the AV media PC 160 through the RF transceiver 102 and/or through another RF transceiver. The controller 164 of the media PC 116 may respond to the action query by querying the rules database 166 to determine whether any applicable rules are defined for the received action query.

For example, a user and/or manufacturer may have defined rules in the database 166 that when a command is received by the control gateway 100 to turn-on the TV 120, further actions are to be initiated to turn-on the satellite/cable tuner 140, to display a guide listing audio-video channels on the TV 120 and/or on the satellite/cable tuner 140, to adjust volume of the TV 120, to change an audio/video mode of the TV 120, to tune the TV 120 and/or the satellite/cable tuner 140 to a defined channel, and/or to activate and control other consumer electronic devices. These further actions may be selectively carried out based on user defined preferences and/or events such as time of day, day of week, and/or receipt of defined email/instant messages. The database 166 may define rules for blocking certain TV channels from being commanded to the TV 120 and/or the satellite/cable tuner 140, and/or rules for blocking certain prerecorded videos from being played unless a defined password is entered to unlock the blocked channel/video and/or unless a defined user has been identified as operating the PDA 155 and/or IR remote control 150.

The operation of the AV media PC 160 may include further functionality as described in U.S. Pat. Nos: 7,016,888; 6,985,450; 6,889,207; 6,795,404; 7,039,698, all of which are incorporated herein in their entireties.

In response to one or more rules defined in the database 166, the AV media PC 160 may transmit commands through the RF transceiver 162 to the control gateway 100 to cause the control gateway 100 to generate a command(s) to the control the functionality of the TV 120 and/or the satellite/cable tuner 140. Thus, for example, the AV media PC 160 may command the gateway 100 to turn-on and further configured the TV 120 (e.g., change to a defined channel, display show listing, set volume at defined level, . . . ) and/or command the gateway 100 to turn-on and further configured the satellite/cable tuner 140 (e.g., change to a defined channel, display show listing, set volume-at defined level, . . . ).

Although the AV media PC 160 has been illustrated as separate from the control gateway 100, it is to be understood that at least some, or entirely all, of the functionality described herein for the AV media PC 160 may be carried out within the control gateway 100 and, accordingly, the rules database 166 may at least partially reside within the control gateway 100.

The TV 120 may conventionally include an IR command window 122, an IR receiver 124, and a controller 126 that controls other components of the TV 120 in response to IR commands received by the IR receiver 124 via the window 122. Similarly, the satellite/cable tuner 140 may conventionally include an IR command window 142, an IR receiver 144, and a controller 146 that controls other components of the satellite/cable tuner 140 in response to IR commands received by the IR receiver 144 via the window 142.

As shown in FIG. 1, the first and second IR transmitters 104, 105 may be communicatively connected to the controller 108 through electrical cables 118 and 119, respectively. The first IR transmitter 104 may be configured to connect to and at least partially cover the IR command window 122 of the TV 120. The second IR transmitter 105 may be configured to connect to and at least partially cover the IR command window 142 of the satellite/cable tuner 140. The first and second IR transmitters 104, 105 may at least substantially cover the respective IR command windows 122, 142 to block IR command signals from other devices from passing through the windows 122, 142 and controlling the TV 120 or satellite/cable tuner 140. Such blocking of command signals from other devices may be useful for preventing the TV 120 and/or satellite/cable tuner 140 from having its state changed without knowledge of the control gateway 100 and/or the AV media PC 160.

For example, the first and second IR transmitters 104, 105 may be positioned so as to block IR signals from IR remote control 150 from being directly received therefrom by the IR receivers 124 and 144 of the TV 100 and satellite/cable tuner 140, respectively. Thus, if a user manipulates the IR remote control 150 to transmit an on/off command to the TV 120, the TV 120 will remain in its present on/off state until the control gateway 100 commands a change in the state of the TV 120. If the on/off command from the IR remote control 150 were allowed to reach the IR receiver 124 of the TV 120 directly, without intervention by the control gateway 100, then the TV 102 may change state without the control gateway 100 and/or AV media PC 160 being aware of that change in state, and which may cause erroneous operation of some functionality described herein for controlling the IR enabled consumer electronic devices.

In some embodiments, the control gateway 100 may be programmed through the user input device 114 and/or via commands received from the remote control 150 and/or the PDA 155 to identify the type of consumer electronic device(s) that it is to control. The control gateway 100 may identify the to be controlled type of consumer electronic device(s) in response to sensing IR control signals, via the IR receiver 106, from a DSRC configured to control that selected electronic device. Thus, a user may press one or more buttons on a DSRC that is configured to control the TV 120 to cause the control gateway 100 to identify the type of TV 120 and to configure the command/protocol converter 110 to translate received IR/RF command signals into output IR commands configured to control that type of TV 120. Similarly, a user may press one or more buttons on a DSRC that is configured to control the satellite/cable, tuner 140 to cause the control gateway 100 to identify the type of satellite/cable tuner 140 and to configure the command/protocol converter 110 to translate received IR/RF command signals into output IR commands configured to control that type/brand of satellite/cable tuner 140. The control gateway 100 may thereby identify a command set that is compatible with the type of TV 120 and/or the type of satellite/cable tuner 14. The command/protocol converter 110 may have a database that maps received DSRC IR commands to types of electronic devices, and/or may learn the IR commands from the DSRC and store the learned IR commands in a non-volatile memory in the command/protocol converter 110. The control gateway 100 may then use the knowledge of the type of electronic device(s) it is controlling to translate received RF signals/IR signals into IR commands that are configured to control that type of electronic device(s).

The control gateway 100 may be powered by an AC power supply, DC (e.g., battery) supply, and/or via a wireless coupling, such as via an inductance field which couples to a power converter in the gateway 100 to generate power for operation of the gateway 100. For example, the gateway 100 may include a power converter with an inductive coil that is configured to generate power from inductively coupled signals from a RF power source.

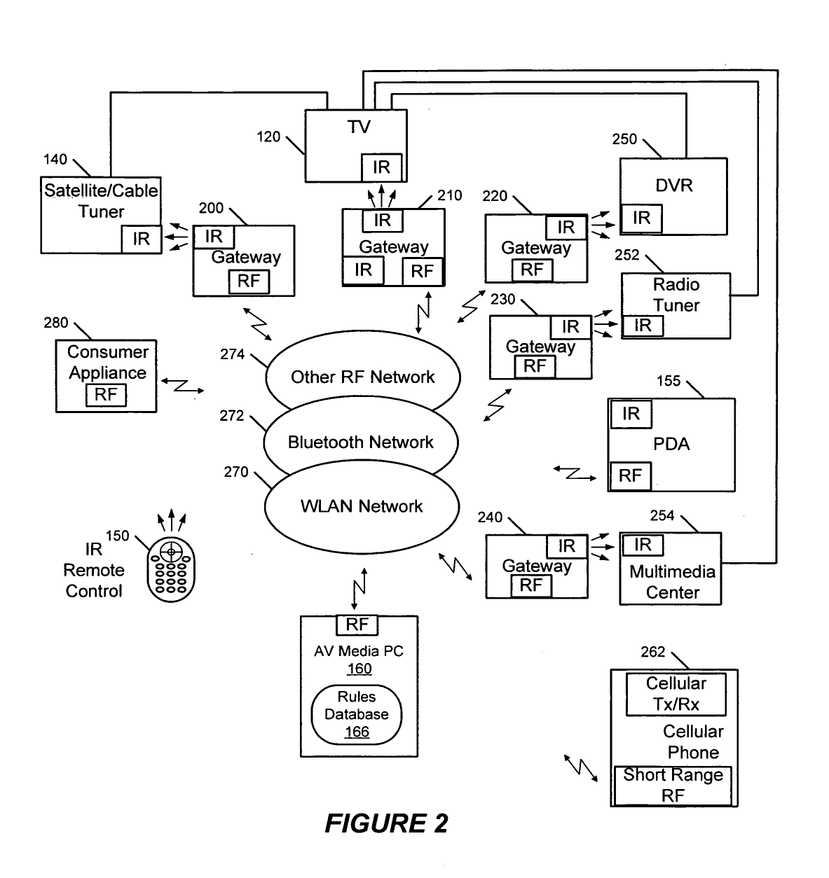

FIG. 2 is a block diagram of another system and related methods in which a plurality of control gateways control various consumer electronic devices in response to RF and/or IR command signals according to some embodiments of the present invention. Referring to FIG. 2, the system may include five exemplary control gateways 200, 210, 220, 230, and 240 that may be respectively configured to control the satellite/cable tuner 140, the television 120, a DVR 250, a satellite/terrestrial radio tuner 252, and an audio-video multimedia center 254. The system may also include the PDA 155, a cellular phone/data terminal 262, a consumer appliance 280, the IR remote control 150, and the AV media PC 160.

In some embodiments, the satellite/cable tuner 140, the TV 120, the DVR 250, the radio tuner 252, the audio-video multimedia center 254, and the PDA 260 are each configured to be at least partially controlled by IR control signals which are received through IR receiver units (illustrated in FIG. 2 as “IR”). For purpose of discussion, each of these IR controlled devices 140, 120, 250, 252, 254, and 260 are controlled by IR control signals that incompatible for controlling any other ones of those devices, such as due to different IR characteristics (e.g., frequency, modulation, etc.) and/or command protocol (e.g., timing of commands, command coding, etc.). Thus, the remote 150 may be configured to generate IR control signals that are configured to control the TV 120, but it is not configured to control any of the other IR controlled devices 140, 250, 252, 254, and 260.

The appliance 280, the PDA 155, the A-V media PC 160, and the cellular phone 262 are configured to communicate through various RF transceiver units (indicated in FIG. 2 as “RF”) which may or may not be compatible with one another. For example, the PDA 155, the A-V media PC 160, the cellular phone 262, and the appliance 280 may be configured to communicate with one another using a RF communication interface that may include, but is not limited to, Bluetooth, Wireless Local Area Network (WLAN) (e.g., 802.11 b-g, or related standard), and/or other RF communication interface. Accordingly, two or more of the RF enabled devices (155, 160, 262, and/or 280) may communicate with one another through a RF network, such as a WLAN network 270, Bluetooth network 272, and/or another RF network 274.

Although two or more of the RF enabled devices (155, 460, 262, and/or 280) may be configured to communicate with one another through RF communications, none of these devices can communicate through those RF interfaces directly with the IR interface of the IR enabled consumer electronic devices (120, 140, 250, 252, and 254).

In accordance with some embodiments, the control gateways 200, 210, 220, 230, and 240 are each configured to translate certain RF commands received through a RF interface (“RF”) and/or certain IR commands received through an IR interface (“IR”) into IR commands which are relayed through one or more IR interfaces associated therewith to control the satellite/cable tuner 140, the television 120, a DVR 250, a satellite/terrestrial radio tuner 252, and an audio-video multimedia center 254, respectively, such as in the manner described above with regard to the control gateway 100 of FIG. 1.

The control gateways 200, 210, 220, 230, and 240 may translate a received RF/IR command signal by converting one or more commands therein into one or more different commands which when output are configured to control an associated one or more of the consumer electronic devices. The conversion can include, but is not limited to, modifying the command protocol (e.g., timing of commands, command coding, etc.) received in a command signal and/or, for received a IR command signal, modifying the IR characteristics of the received IR command signal (e.g., frequency, modulation, etc.) to generate an output IR command signal for transmission therefrom.

By way of example, the remote 150 may be configured to control the TV 120 through the IR command signals. Accordingly, the remote 150 may transmit conventional commands to the TV 120 to, for example, turn-on, turn-off, change channel, change volume, and/or setup features of the TV 120. In accordance with some embodiments of the present invention, a user may operate the remote 150 to control the TV 120 and at least some other ones of the IR enabled devices 140, 250, 252, and 254 and/or to control at least some of the RF enabled devices RF enabled devices 160, 280, 262, and 155. The user may operate the remote 150 to transmit an IR command to turn-on the TV 120. The gateway 210, which is associated with the TV 120, may receive that IR command through its IR interface, and may relay that command through its RF interface to the media PC 160. The media PC 160 may query the rules database 166 to determine whether any applicable rules are defined for the action requested by the user, such as was described above with regard to FIG. 1.

For example, rules in the database 166 may define that when the TV 120 is turned on, further actions are to be initiated to turn-on and further configure the operation of the satellite/cable tuner 140, DVR 250, and/or the radio tuner 252. Exemplary actions may include actions for the satellite/cable tuner 140 to display a guide listing TV channels and associated information, to tune the satellite/cable tuner 140 to a defined channel based on user defined preferences and/or time of day and/or day or week, to cause the DVR 250 to record a TV channel to which the TV 120 is tuned, to cause the DVR 250 to display a list of previously recorded videos, and/or to set the radio tuner 252 to a defined setting, such as an auxiliary setting, to route audio signals from the TV 120, the satellite/cable tuner 140, and/or the DVR 250 through speakers connected to the radio tuner 252. The rules database 166 may define rules for blocking certain TV channels from being commanded to the TV 120 and/or to the satellite/cable tuner 140, and/or rules for blocking certain prerecorded videos from being played unless a defined password is entered to unlock the blocked channel/video and/or unless a defined user has been identified as operating the remote 150. The rules database 166 may define rules for turning on the TV 120 when the satellite/cable tuner 140 and/or DVR 150 is turned on, and/or to changes settings and/or modes of the radio receiver 252 in response to respective ones of the TV 120, satellite/cable tuner 140, and/or DVR 150 being turned-on and/or turned-off and/or in response to a change in settings associated with those devices.

In response to one or more rules defined in the rules database 16, the media PC 160 may transmit commands through its RF interface to one or more of the gateways 200, 210, 220, 230, and/or 240 to control one or more of the IR enabled devices 140, 120, 250,. 252, and/or 254, and/or may transmit commands through its RF interface to control one or more of the RF enabled devices 280, 155, and/or 262. Thus, for example, the media PC 160 may command the gateway 210 to turn-on and further configure the TV 120 (e.g., change to a defined channel, display show listing, set volume at defined level, . . . ), command the gateway 140 to turn-on and further configure the satellite/cable tuner 140 (e.g., change to a defined channel, display show listing, set volume at defined level, . . . ), command the gateway 220 to turn-on and further configure the DVR 250 (e.g., change to a defined channel, display show listing, set volume at defined level, . . . ), command the gateway 230 to turn-on and further configure the radio tuner 252 (e.g., change to a defined radio station, change modes to conduct audio signals from a selected one of the devices 140, 120, 250, 254, set volume at defined level, . . . ), and/or command the gateway 240 to turn-on and further configure the multimedia center 254 (e.g., record an audio/video signal and/or play a pre-recorded audio/video signal). Alternatively, the media PC 160 may command the control gateway 210 to relay commands it receives from the media PC 160 to one or more of the other gateways 200, 220, 230, and 240 to carry out the actions described herein or that may otherwise be defined to control the associated devices 140, 120, 250, 252, and/or 254. In some alternative embodiments, one or more of the control gateways 200, 210, 220, 230, and 240, the PDA 155, and/or the cellular phone 262 may be configured to carry out at least some, or entirely all, of the functionality described herein for the media PC 160.

By way of another example, the appliance 280 may be a kitchen appliance, such as an oven, which may respond to a timer or cooking sensor indicating that it has completed cooking of food by communicating through its RF interface to the gateway 210 (via its RF interface) to turn-on the radio tuner 252 and transmit there through an audible announcement that the oven has completed cooking. Similarly, the appliance 280 may communicate through its RF interface to gateway 210 to turn-on the TV 120 and to display a message, to generate an audible announcement, and/or to mute sound for a present TV show to indicate that the oven has completed cooking and/or so that a user may otherwise hear an audible announcement that is generated by the appliance 280. Similarly, the appliance 280 may communicate through its RF interface to gateway 250 to turn-on and initiate recording by the DVR 250 of a presently viewed TV channel in anticipation of the user needing to temporarily stop viewing while attending to the cooked food or other associated action indicated by the appliance 280. Alternatively or additionally, the appliance 280 may communicate through its RF interface via the Bluetooth network 272, the WLAN network 270, and/or the other RF network 274 to the media PC 160 to cause the media PC 160 to query the rules database 166 to determine one or more actions in response to an oven completing cooking, a dish/clothes washing machine completing a cycle, a clothes dryer completing a cycle, and/or other actions associated with these or other types of consumer appliances.

The IR enabled devices 140, 120, 250, 252, and/or 254 may similarly communicate IR command signals to the control gateways 200, 210, 220, 230, which may be translated by the control gateways and communicated as RF command signals via one or more of the networks 270-274 to the RF enabled devices 160, 280, 155, and/or 262.

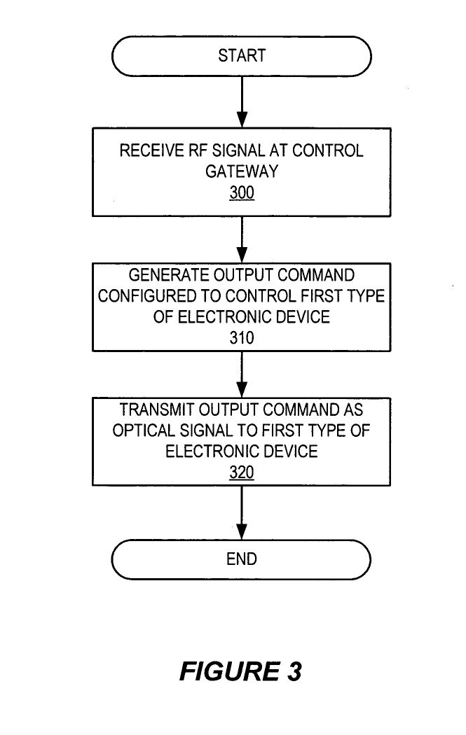

FIG. 3 is a flowchart of methods for converting RF control signals to IR control signals according to some embodiments of the present invention. RF signals are received at Block 300 in a control gateway. The control gate generates at Block 310 an output command that is configured to control a first type of consumer electronic device in response to the received RF signals. The control gateway transmits at Block 320 the output command as an optical signal to the first type of consumer electronic device.

As will be appreciated by one of skill in the art, the present invention may be embodied as a method, system, or computer program product. Accordingly, the present invention may take the form of an entirely hardware embodiment, a software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language and/or a lower level assembler language. The program code may execute entirely on the user's computer (i.e., controller of the user's mobile terminal), partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Furthermore, the present invention was described in part above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and schematic diagrams of FIGS. 1 and 2 illustrate the architecture, functionality, and operations of some embodiments of methods, systems, and computer program products in accordance with various embodiments of the present invention. In this regard, each block may represent a module, segment, or portion of code, which comprises one or more executable instructions -for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved. Moreover, the functionality of a given block of the flowcharts and/or block diagrams may be separated into multiple blocks and/or the functionality of two or more blocks of the flowcharts and/or block diagrams may be at least partially integrated.

The term “controller”, as used herein, may include hardware, such as discrete time logic (e.g., gate array), programmable data processing apparatus, and/or continuous time analog circuitry, and/or executable software that is configured to carry out at least some of the functionality described herein.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A control gateway configured to control at least one consumer electronic device, the control gateway comprising:
an optical transmitter unit that is configured to transmit optical signals compatible with a first type of consumer electronic device;
a radio frequency (RF) transceiver unit that is configured to receive RF signals; and
a controller that is configured to generate an output command configured to control the first type of consumer electronic device in response to RF signals received by the RF transceiver unit, and to communicate the output command through the optical transmitter unit to the first type of consumer electronic device.

2. The control gateway of claim 1, wherein the RF transceiver comprises a wireless RF network interface configured to communicate through a wireless RF network with network devices, and the controller is further configured to identify an input command from one or more of the network devices that is intended for use in controlling the first type of consumer electronic device, and to generate the output command in response to the input command for communication through the optical transmitter unit to the first type of consumer electronic device.

3. The control gateway of claim 2, wherein the wireless RF network interface comprises a wireless local area network (WLAN) interface, and the controller is further configured to identify the input command from a WLAN transmitting device, and to convert the input command to the output command for communication through the optical transmitter unit to the first type of consumer electronic device.

4. The control gateway of claim 2, wherein the wireless RF network interface comprises a wireless Bluetooth network interface, and the controller is further configured to identify the input command from a Bluetooth transmitting device, and to convert the identified command to the output command for communication through the optical transmitter unit to the to first type of consumer electronic device.

6. The control gateway of claim 2, wherein the controller is further configured to convert the identified input command into at least one output command configured to control a television, a digital video recorder, a video cassette recorder, a cable receiver, a satellite receiver, and/or a stereo device, and to communicate the at least one output command through the optical transmitter unit to the television, the digital video recorder, the video cassette recorder, the cable receiver, the satellite receiver, and/or the stereo device.

7. The control gateway of claim 6, wherein the controller is further configured to convert the identified input command into a plurality of output commands, each having a different protocol for controlling a different one of the television, the digital video recorder, the video cassette recorder, the cable receiver, the satellite receiver, and/or the stereo device, and to sequentially transmit the plurality of output commands through the optical transmitter unit.

8. The control gateway of claim 7, wherein the controller is further configured to convert the identified input command into a first output command configured to turn-on the television, into a second output command configured to turn-on at least one of cable receiver and the satellite receiver, and into a third output command configured to turn-on the stereo device, and to sequentially transmit the first, second, and third output commands through the optical transmitter unit.

9. The control gateway of claim 2, wherein the networked device with which the wireless RF network interface is configured to communicate comprises a personal data assistant device, a consumer appliance, a cellular phone, and/or a personal computer, and the controller is further configured to convert the identified input command from the network device into at least one output command configured to control the first type of consumer electronic device, and to communicate the at least one output command through the optical transmitter unit to the first type of consumer electronic device.

10. The control gateway of claim 9, wherein the controller is further configured to identify the input command received by the wireless RF network interface from a consumer appliance that comprises an oven, a dishwasher, a washing machine, and/or a phone device, and is configured to convert the identified input command into at least one output command configured to control the consumer appliance, and to communicate the at least one output command through the optical transmitter unit to the first type of consumer electronic device.

11. The control gateway of claim 10, wherein the controller is further configured to respond to the identified input command indicating occurrence of an event associated with the consumer appliance by converting the input command to the at least one output command and communicating the at least one output command through the optical transmitter unit to the first type of consumer electronic device.

12. The control gateway of claim 11, wherein the first type of consumer electronic device comprises a television, and the at least one output command generated by the controller comprises a command configured to mute sound by the television to alert a user of occurrence of the event associated with the consumer appliance.

13. The control gateway of claim 1 1, wherein the first type of consumer electronic device comprises a television, and the at least one output command generated by the controller comprises a command configured to display a message on the television to alert a user of occurrence of the event associated with the consumer appliance.

14. The control gateway of claim 11, wherein the first type of consumer electronic device comprises a digital video recorder configured to record a channel of an associated cable tuner and/or satellite tuner, and the at least one output command generated by the controller comprises a command configured to initiate recording by the digital video recorder.

15. The control gateway of claim 1, wherein:
the controller is enclosed within packaging that is separate from packaging enclosing the optical transmitter;
the optical transmitter is communicatively connected to the controller through an electrical cable; and
the optical transmitter is configured to connect to and at least partially cover an optical command window of the first type of consumer electronic device.

16. The control gateway of claim 15, wherein the optical transmitter is further configured to at least substantially cover the optical command window of the of the first type of consumer electronic device and block optical signals from another device from bypassing the optical transmitter and passing through the optical command window.

17. The control gateway of claim 1, further comprising an optical receiver unit that is configured to receive optical signals that are configured to control a second type of consumer electronic device and which are not configured to control at least some functionality of the first type of consumer electronic device, wherein the controller is further configured to generate an output command configured to control the first type of consumer electronic device in response to optical signals received by the optical receiver from the second type-of consumer electronic device and to communicate the output command through the optical transmitter unit to the first type of consumer electronic device.

18. The control gateway of claim 1, further comprising an optical receiver unit that is configured to receive optical signals that are configured to control a second type of consumer electronic device and which are not configured to control at least some functionality of the first type of consumer electronic device, wherein the controller is further configured to generate an action query and to communicate the action query through the RF transceiver to a control device separate from the control gateway, and the controller is further configured to generate the output command configured to control the first type of consumer electronic device further in response to a command response received by the RF transceiver from the control device and to communicate the output command through the optical transmitter unit to the first type of consumer electronic device.

19. The control gateway of claim 1, further comprising an optical receiver unit that is configured to receive optical signals that are configured to control the first type of consumer electronic device, wherein the controller is further configured to identify a command set that is compatible with the first type of consumer electronic device in response to identifying the optical signals as being configured to control the first type of consumer electronic device.

20. A method of controlling at least one consumer electronic device from a control gateway, the method comprising:
receiving radio frequency (RF) signals in the control gateway;
generating in the control gateway an output command that is configured to control a first type of consumer electronic device in response to the received RF signals; and
transmitting the output command as an optical signal from the control gateway to the first type of consumer electronic device.
